(19) United States
(12) Patent Application Publication
(10) Pub. No.: US 2026/0297768 A1
(43) Pub. Date: Oct. 1, 2026

(54) ELECTROCHEMICAL CELL STACK INTERCONNECT INCLUDING SCREEN PRINTED FEATURES AND METHODS OF FORMING SAME

(71) Applicant: Bloom Energy Corporation, San Jose, CA (US)

(72) Inventors: Harald HERCHEN, Los Altos, CA (US); Richard A. VILLA, San Jose, CA (US); Cheng-Yu LIN, Cupertino, CA (US); Emad EL BATAWI, Aurora, CO (US)

(21) Appl. No.: 19/089,883

(22) Filed: Mar. 25, 2025

(51) Int. Cl. C25B 9/65; H01M 8/0208; H01M 8/0215; H01M 8/026

(52) U.S. Cl. CPC C25B 9/65; H01M 8/0208; H01M 8/0215; H01M 8/026

(57) ABSTRACT

A method of forming an interconnect for an electrochemical cell stack includes providing a metal alloy interconnect plate having a flat air side and an opposing fuel side containing fuel ribs, and printing metal oxide air ribs on the air side using at least one ink containing metal oxide particles.

### FIELD

The embodiments of the present invention generally relate to electrochemical cell stack interconnects including features formed by screen printing and methods of forming the same.

### BACKGROUND

Electrochemical cell systems include fuel cell and electrolyzer cell systems. In a high temperature fuel cell system, such as a solid oxide fuel cell (SOFC) system for power generation, an oxidizing flow is directed to the cathode side of the fuel cell while a fuel flow is directed to the anode side of the fuel cell. The oxidizing flow is typically air, while the fuel flow can be a hydrocarbon fuel, such as methane, natural gas, pentane, ethanol, or methanol, as well as hydrocarbon fuels blended with pure hydrogen. The SOFC, operating at a temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit.

In an electrolyzer system, such as a solid oxide electrolyzer system, water (e.g., steam) is separated into hydrogen and oxygen by applying a voltage across the electrolyzer cells. Since the cathode and anode are reversed between SOFC and SOEC (i.e. a SOFC cathode is a SOEC anode, and a SOFC anode is a SOEC cathode), going forward, the SOFC cathode (SOEC anode) may be referred to as the air electrode, and the SOFC anode (SOEC cathode) may be referred to as the fuel electrode.

Fuel cell stacks may be either internally or externally manifolded for fuel and air. In internally manifolded stacks, the fuel and air are distributed to each cell using risers contained within the stack. Fuel cell stacks may also be internally manifolded for fuel and externally manifolded for air. When configured in this fashion, the gas flows through openings or holes in the supporting layer of each fuel cell, such as the electrolyte layer, and gas flow separator of each cell.

Fuel cell stacks are frequently built from a multiplicity of cells in the form of planar elements, tubes, or other geometries. Fuel and air are provided to electrochemically active surfaces, which can be large. One component of a fuel cell stack is the so called gas flow separator (referred to as a gas flow separator plate in a planar stack) that separates the individual cells in the stack. In a fuel cell configuration for producing electricity, the gas flow separator plate separates fuel, such as hydrogen or a hydrocarbon fuel, flowing to the fuel electrode (i.e., anode) of one cell in the stack from oxidant, such as air, flowing to the air electrode (i.e., cathode) of an adjacent cell in the stack. Frequently, the gas flow separator plate is also used as an interconnect which electrically connects the fuel electrode of one cell to the air electrode of the adjacent cell. In this case, the gas flow separator plate which functions as an interconnect is made of or contains an electrically conductive material. Gas flow separator plates may be coated with barrier layers before incorporating such plates into fuel cell stacks.

### SUMMARY

According to various embodiments, an interconnect for an electrochemical cell stack includes a metal alloy interconnect plate comprising an air side and an opposing fuel side; fuel ribs located on the fuel side; and metal oxide air ribs located on the air side, wherein the metal oxide air ribs comprise at least 50 atomic percent oxygen throughout an entire height of the metal oxide ribs.

According to various embodiments, a method of forming an interconnect for an electrochemical cell stack includes providing a metal alloy interconnect plate having a flat air side and an opposing fuel side containing fuel ribs, and printing metal oxide air ribs on the air side using at least one ink containing metal oxide particles.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the detailed description provided below serve to explain the features of the invention.

FIG. 1A is a perspective view of an externally manifolded electrochemical cell column, according to various embodiments of the present disclosure.

FIG. 1B is a perspective view of a solid oxide electrochemical cell stack included in the column of FIG. 1A, according to various embodiments of the present disclosure.

FIG. 1C is a side cross-sectional view of a portion of the stack of FIG. 1B, according to various embodiments of the present disclosure.

FIG. 2A is a top view of the air side of an interconnect of the column of FIG. 1A, according to various embodiments of the present disclosure.

FIG. 2B is a top view of a fuel side of the interconnect of FIG. 2A, according to various embodiments of the present disclosure.

FIG. 3A is a perspective view of an electrochemical cell column, according to various embodiments of the present disclosure.

FIG. 3B is an exploded perspective view of a portion of the column of FIG. 3A.

FIG. 3C is a top view of the fuel side of an interconnect included in the column of FIG. 3A, according to various embodiments of the present disclosure.

FIG. 3D is a schematic view of an electrochemical cell included in the column of FIG. 3A, according to various embodiments of the present disclosure.

FIG. 4A is a plan view of an air side of an interconnect, according to various embodiments of the present disclosure.

FIG. 4B is a plan view showing a fuel side of the interconnect of FIG. 4A.

FIGS. 5A and 5B are top views showing the air sides of interconnect plates prior to forming air side surface features, according to various embodiments of the present disclosure.

FIGS. 6A-6C illustrate a method of forming surface features on a portion of an interconnect plate, according to various embodiments of the present disclosure.

FIG. 6D is a cross-sectional view of an air rib formed by various embodiments.

FIGS. 6E and 6F are top views of barrier layers that may be formed by methods of various embodiments.

### DETAILED DESCRIPTION

The various embodiments will be described in detail with reference to the accompanying drawings. The drawings are not necessarily to scale and are intended to illustrate various features of the invention. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

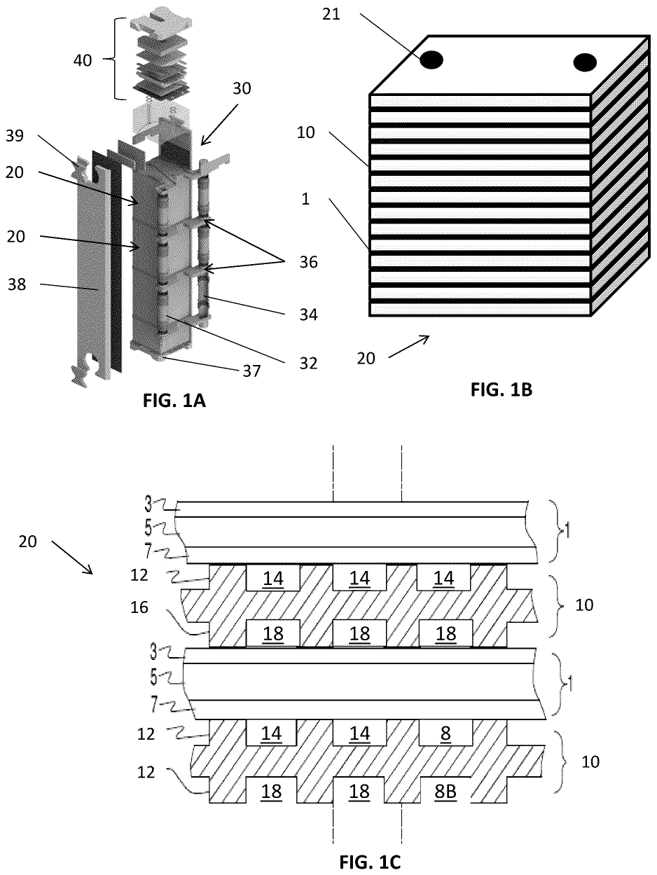

FIG. 1A is a perspective view of an externally manifolded electrochemical cell column 30, FIG. 1B is a perspective view of one solid oxide electrochemical cell stack 20 included in the column 30 of FIG. 1A, and FIG. 1C is a side cross-sectional view of a portion of the stack 20 of FIG. 1B.

In various embodiments, the column 30 may be described as being operated as a solid oxide fuel cell (SOFC) column 30. However, it should be noted that the electrochemical column 30 may also be operated as an electrolyzer column (e.g., a solid oxide electrolyzer cell (SOEC) column). In the SOEC column, the anode is the air electrode, and the cathode is the fuel (e.g., steam) electrode, while in a SOFC column the anode is the fuel electrode, and the cathode is the air electrode. Thus, the electrode to which the fuel (e.g., hydrogen or hydrocarbon fuel in a SOFC, and steam in a SOEC) is supplied may be referred to as the fuel electrode and the opposing electrode may be referred to as the air electrode in both SOFC and SOEC cells.

Referring to FIGS. 1A and 1B, the column 30 may include one or more stacks 20, a fuel inlet conduit 32, an anode exhaust conduit 34, and anode feed/return assemblies 36 (e.g., anode splitter plates (ASPs) 36). The column 30 may also include side baffles 38 and a compression assembly 40. The side baffles 38 may be connected to the compression assembly 40 and an underlying column component (e.g., column base 37) by ceramic connectors 39. The fuel inlet conduit 32 is fluidly connected to the ASPs 36 and is configured to provide the fuel feed to each ASP 36, and anode exhaust conduit 34 is fluidly connected to the ASPs 36 and is configured to receive anode fuel exhaust from each ASP 36.

The ASPs 36 are disposed between the stacks 20 and are configured to provide a hydrocarbon fuel containing fuel feed to the stacks 20 and to receive fuel exhaust from the stacks 20. For example, the ASPs 36 may be fluidly connected to internal fuel riser channels 21 formed in the stacks 20, as discussed below.

Referring to FIGS. 1B and 1C, the stack 20 includes multiple fuel cells 1 that are separated by interconnects 10, which may also be referred to as gas flow separator plates or bipolar plates. Each fuel cell 1 includes a cathode electrode 3 (e.g., an air electrode), a solid oxide electrolyte 5, and an anode electrode 7 (i.e., a fuel electrode).

Each interconnect 10 electrically connects adjacent fuel cells 1 in the stack 20. In particular, an interconnect 10 may electrically connect the anode electrode 7 of one fuel cell 1 to the cathode electrode 3 of an adjacent fuel cell 1. FIG. 1C shows that the lower fuel cell 1 is located between two interconnects 10.

Each interconnect 10 includes fuel ribs 12 that at least partially define fuel channels 14 and air ribs 16 that at least partially define air channels 18. As discussed in more detail below, the fuel ribs 12 and/or the air ribs 16 may be formed of a metal oxide material, while a remainder of the interconnect 10 may be formed of a Cr—Fe alloy or stainless steel. The interconnect 10 may operate as a gas-fuel separator that separates a fuel, such as a hydrocarbon fuel, flowing to the fuel electrode (i.e. anode 7) of one cell in the stack from oxidant, such as air, flowing to the air electrode (i.e. cathode 3) of an adjacent cell in the stack. At either end of the stack 20, there may be an air end plate or fuel end plate (not shown) for providing air or fuel, respectively, to the end electrode. Alternatively, the air end plate or fuel end plate may comprise the same interconnect 10 used throughout the stack 20.

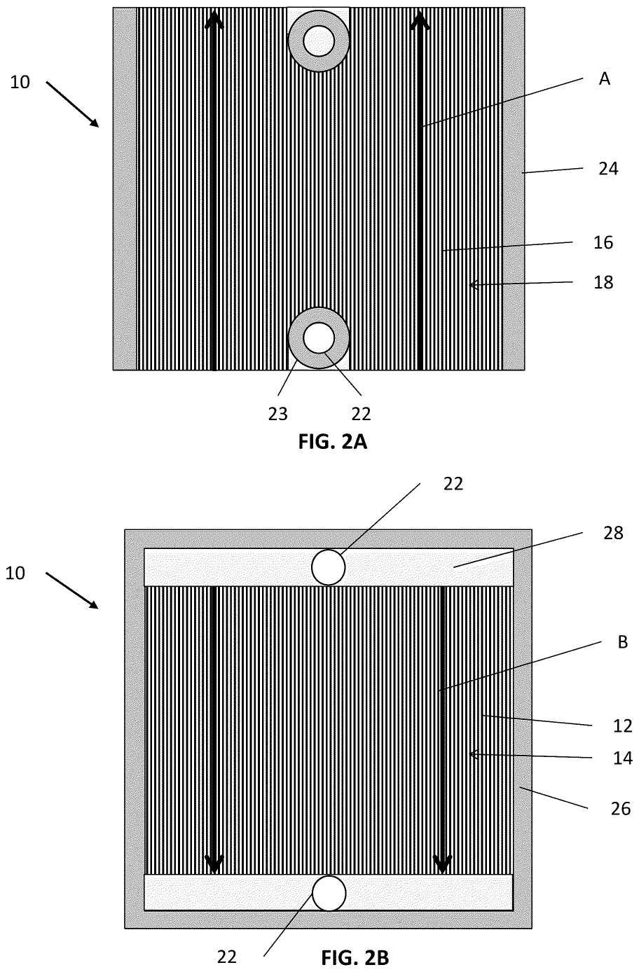

FIG. 2A is a top view of the air side of an exemplary interconnect 10, and FIG. 2B is a top view of a fuel side of the interconnect 10. Referring to FIGS. 1C and 2A, the air side includes the air channels 18. Air flows through the air channels 18 to a cathode electrode 3 of an adjacent fuel cell 1. In particular, the air may flow across the interconnect 10 in a first direction A as indicated by the arrows.

Ring seals 23 may surround fuel holes 22 of the interconnect 10, to prevent fuel from contacting the air electrode. Peripheral strip-shaped seals 24 are located on peripheral portions of the air side of the interconnect 10. The seals 23, 24 may be formed of a glass material. The peripheral portions may be in the form of an elevated plateau which does not include ribs or channels. The surface of the peripheral regions may be coplanar with tops of the air ribs 16.

Referring to FIGS. 1C and 2B, the fuel side of the interconnect 10 may include the fuel channels 14 and fuel manifolds 28 (e.g., fuel plenums). Fuel flows from one of the fuel holes 22, into the adjacent manifold 28, through the fuel channels 14, and to an anode 7 (i.e., fuel electrode) of an adjacent fuel cell 1. Excess fuel and anode exhaust may flow into the other fuel manifold 28 and then into the adjacent fuel hole 22. In particular, the fuel may flow across the interconnect 10 in a second direction B, as indicated by the arrows. The second direction B may be opposite from the first direction A (see FIG. 2A). Based upon the opposite directions of air and fuel flow as illustrated in FIGS. 2A and 2B, an interconnect configured in this manner can be characterized as a counter-flow interconnect. If the directions of the air and fuel flow were flowing in the same direction, albeit on opposite sides of the interconnect, an interconnect configured in that manner could be characterized as a co-flow interconnect.

A frame-shaped seal 26 is disposed on a peripheral region of the fuel side of the interconnect 10. The peripheral region may be an elevated plateau which does not include ribs or channels. The surface of the peripheral region may be coplanar with tops of the fuel ribs 12. The surface of the manifold 28 may be coplanar with the bottom of the fuel channels 14 or optionally may be below the surface of the bottom of the fuel channels 14. The depth of the surface of the manifold 28 may also vary from the fuel holes towards the peripheral region of the interconnect 10.

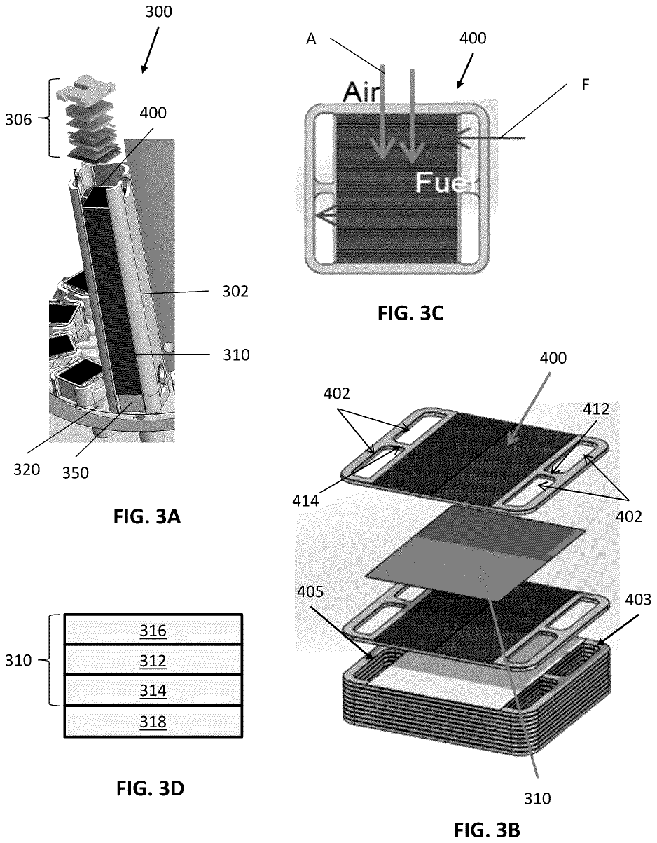

FIG. 3A is a perspective view of a fuel cell column, according to various embodiments of the present disclosure. In this embodiment, the column comprises a single electrochemical cell stack (e.g., fuel cell or electrolyzer cell stack) 300. FIG. 3B is an exploded perspective view of a portion of the column of FIG. 3A, FIG. 3C is a top view of the fuel side of an interconnect 400 included in the column (i.e., the stack 300), and FIG. 3D is a schematic view of an electrochemical cell (e.g., fuel cell or electrolyzer cell) included in the column (i.e., the stack 300).

Referring to FIGS. 3A-3D, the fuel cell stack 300, which may also be referred to as a fuel cell column because it lacks ASPs, includes multiple fuel cells 310 that are separated by interconnects 400, which may also be referred to as gas flow separator plates or bipolar plates. One or more stacks 300 may be thermally integrated with other components of a fuel cell power generating system (e.g., one or more anode tail gas oxidizers, fuel reformers, fluid conduits and manifolds, etc.) in a common enclosure or “hotbox.”

The interconnects 400 are made from an electrically conductive metal material. For example, the interconnects 400 may comprise a chromium alloy, such as a Cr—Fe alloy or stainless steel. The interconnects 400 may typically be fabricated using a powder metallurgy technique that includes pressing and sintering a Cr—Fe powder, which may be a mixture of Cr and Fe powders or an Cr—Fe alloy powder, to form a Cr—Fe interconnect in a desired size and shape (e.g., a “net shape” or “near net shape” process). A suitable Cr—Fe alloy may comprise more than about 90% chromium by weight, such as about 94-96% (e.g., 95%) chromium by weight. An interconnect 400 may also contain less than about 10% iron by weight, such as about 4-6% (e.g., 5%) iron by weight.

Each fuel cell 310 may include a solid oxide electrolyte 312, an anode 314, and a cathode 316. In some embodiments, the anode 314 and the cathode 316 may be printed on the electrolyte 312. In other embodiments, a conductive layer 318, such as a nickel mesh, may be disposed between the anode 314 and an adjacent interconnect 400. The fuel cell 310 does not include through-holes, such as the fuel holes extending through the electrolyte layers of fuel cells illustrated in FIG. 1B. As such, the fuel cell 310 may avoid cracks that could be generated due to the presence of such through-holes.

An upper most interconnect 400 and a lowermost interconnect 400 of the stack 300 may be different ones of an air end plate or fuel end plate including features for providing air or fuel, respectively, to an adjacent end fuel cell 310. As used herein, an “interconnect” may refer to either an interconnect located between two fuel cells 310 or an end plate located at an end of the stack and directly adjacent to only one fuel cell 310. Since the stack 300 does not include ASPs and the end plates associated therewith, the stack 300 may include only two end plates. As a result, stack dimensional variations associated with the use of intra-column ASPs may be avoided. Alternatively, the end plates may comprise the same design as the interconnect 400.

The stack 300 may include side baffles 302, a fuel plenum 350, and a compression assembly 306. The side baffles 302 may be formed of a ceramic material and may be disposed on opposing sides of the fuel cell stack 300 containing stacked fuel cells 310 and interconnects 400. The side baffles 302 may connect the fuel plenum 350 and the compression assembly 306, such that the compression assembly 306 may apply pressure to the stack 300. The side baffles 302 may be curved baffle plates, such that each baffle plate covers at least portions of three sides of the fuel cell stack 300. For example, one baffle plate may fully cover the fuel inlet riser side of the stack 300 and partially cover the adjacent front and back sides of the stack, while the other baffle plate fully covers the fuel outlet riser side of the stack and partially covers the adjacent portions of the front and back sides of the stack. The remaining uncovered portions for the front and back sides of the stack allow air to flow through the stack 300. The curved baffle plates provide an improved air flow control through the stack. The fuel plenum 350 may be disposed below the stack 300 and may be configured to provide a hydrogen-containing fuel feed to the stack 300 and may receive an anode fuel exhaust from the stack 300. The fuel plenum 350 may be connected to fuel inlet and outlet conduits 320 which are located below the fuel plenum 350.

Each interconnect 400 electrically connects adjacent fuel cells 310 in the stack 300. In particular, an interconnect 400 may electrically connect the anode electrode of one fuel cell 310 to the cathode electrode of an adjacent fuel cell 310. As shown in FIG. 3C, each interconnect 400 may be configured to channel air in a first direction A, such that the air may be provided to the cathode of an adjacent fuel cell 310. Each interconnect 400 may also be configured to channel fuel in a second direction F, such that the fuel may be provided to the anode of an adjacent fuel cell 310. Directions A and F may be perpendicular, or substantially perpendicular. As such, the interconnects 400 may be referred to as crossflow interconnects.

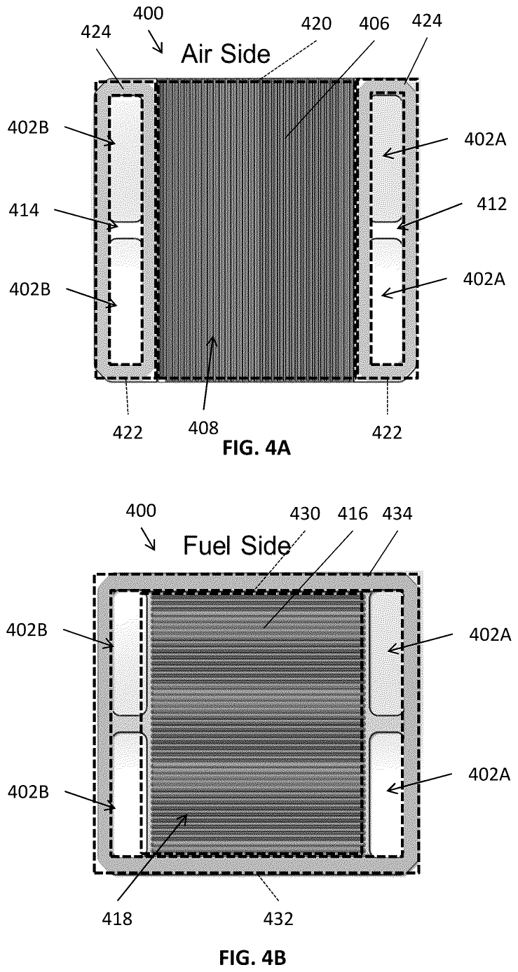

The interconnect 400 may include fuel holes 402 that extend through the interconnect 400 and that are configured for fuel distribution. For example, the fuel holes 402 may include one or more fuel inlets 402A and one or more fuel (e.g., anode exhaust) outlets 402B, which may also be referred to as anode exhaust outlets 402B (see FIG. 4A). The fuel inlets and outlets 402A, 402B may be disposed outside of the perimeter of the fuel cells 310. As such, the fuel cells 310 may be formed without corresponding through-holes for fuel flow. The combined length of the fuel inlets 402A and/or the combined length of the fuel outlets 402B may be at least 75% of a corresponding length of the interconnect 400 e.g., a length taken in direction A.

In one embodiment, each interconnect 400 contains two fuel inlets 402A separated by a neck portion 412 of the interconnect 400, as shown in FIG. 4A. However, more than two fuel inlets 402A may be included, such as three to five inlets separated by two to four neck portions 412. In one embodiment, each interconnect 400 contains two fuel outlets 402B separated by a neck portion 414 of the interconnect 400, as shown in FIG. 4A. However, more than two fuel outlets 402B may be included, such as three to five outlets separated by two to four neck portions 414.

The fuel inlets 402A of adjacent interconnects 400 may be aligned in the stack 300 to form one or more fuel inlet risers 403 (see FIG. 3B). The fuel outlets 402B of adjacent interconnects 400 may be aligned in the stack 300 to form one or more fuel outlet risers 405. The fuel inlet riser 403 may be configured to distribute fuel received from the fuel plenum 350 to the fuel cells 310. The fuel outlet riser 405 may be configured to provide anode exhaust received from the fuel cells 310 to the fuel plenum 350.

Unlike the flat side baffles 38 of FIG. 1A, the side baffles 302 may be curved around edges of the interconnects 400. In particular, the side baffles 302 may be disposed around the fuel inlets 402A and outlets 402B of the interconnects 400. Accordingly, the side baffles may more efficiently control air flow through air channels 408 of the interconnects 400, which are exposed between the side baffles 302 and are described in detail with regard to FIGS. 4A and 4B. In various embodiments, the stack 300 may include from about 200 to 400 fuel cells, such as about 250 to 350 fuel cells, more particularly from about 275 to 325 fuel cells, which may be provided with fuel using only the fuel risers 403, 405. The crossflow configuration allows for a large number of fuel cells to be provided with fuel, without the need for ASPs or external stack fuel manifolds, such as external conduits 32, 34 shown in FIG. 1A.

Other stack configurations are possible in addition to stack 20 and stack 300. In particular, the stacks may be internally manifolded for fuel and air with fuel and air risers extending through openings in the fuel cell layers and/or in the interconnect plates. Such fuel cell stacks are disclosed in U.S. patent application Ser. No. 63/598,678, filed on Nov. 14, 2023, entitled “Internally Manifolded Interconnects with Plural Flow Directions and Electrochemical Cell Column Including Same,” which is incorporated herein by reference in its entirety.

Each interconnect 400 may be made of or may contain an electrically conductive material, such as a metal alloy (e.g., chromium-iron alloy) which has a similar coefficient of thermal expansion to that of the solid oxide electrolyte in the cells (e.g., a difference of 0-10%). For example, the interconnects 400 may comprise a metal (e.g., a chromium-iron alloy, such as 4-6 weight percent iron, optionally 1 or less weight percent yttrium and balance chromium alloy) and may electrically connect the anode or fuel-side of one fuel cell 310 to the cathode or air side of an adjacent fuel cell 310. An electrically conductive contact layer, such as a nickel contact layer (e.g., a nickel mesh), may be provided between anode and each interconnect 400. Another optional electrically conductive contact layer may be provided between the cathode electrodes and each interconnect 400.

A surface of an interconnect 400 that in operation is exposed to an oxidizing environment (e.g., air), such as the cathode-facing side of the interconnect 400 in a SOFC configuration (or anode or air electrode in a SOEC configuration), may be coated with a protective coating layer in order to decrease the growth rate of a chromium oxide surface layer on the interconnect and to suppress evaporation of chromium vapor species which can poison the air electrode Typically, the coating layer, which can comprise a perovskite such as lanthanum strontium manganite (LSM), may be formed using a spray coating or dip coating process. Alternatively, other metal oxide coatings, such as a spinel, such as manganese cobalt oxide (MCO), can be used instead of or in addition to LSM. Any spinel having the composition Mn₂₋ₓ Co₁₊ₓO₄ (0≤x≤1) or written as y(Mn₃O₄)+(1−y)(Co₃O₄), where (⅓≤y≤⅔) or written as (Mn, Co)₃ O₄ may be used. In other embodiments, a mixed layer of LSM and MCO, or a stack of LSM and MCO layers may be used as the coating layer.

FIGS. 4A and 4B are plan views showing, respectively, an air side and a fuel side of the cross flow interconnect 400, according to various embodiments of the present disclosure. Referring to FIG. 4A, the air side of the interconnect 400 may include air ribs 406 configured to at least partially define air channels 408 configured to provide air to the air electrode of an electrochemical cell (e.g., fuel cell) 310 disposed thereon. The air side of the interconnect 400 may be divided into an air flow field 420 including the air channels 408, and riser seal surfaces 422 disposed on two opposing sides of the air flow field 420. One of the riser seal surfaces 422 may surround the fuel inlets 402A and the other riser seal surface 422 may surround the fuel outlets 402B. The air channels 408 and air ribs 406 may extend completely across the air side of the interconnect 400, such that the air channels 408 and air ribs 406 terminate at opposing peripheral edges of the interconnect 400. In other words, when assembled into a stack 300, opposing ends of the air channels 408 and air ribs 406 are disposed on opposing (e.g., front and back) outer surfaces of the stack, to allow the blown air to flow through the stack. Therefore, the stack may be externally manifolded for air. In an alternative embodiment, some or all of the ribs 406 may terminate at a location spaced from the opposing peripheral edges of the interconnect 400.

Riser seals 424 may be disposed on the riser seal surface 422. For example, one riser seal 424 may surround the fuel inlets 402A, and one riser seal 424 may surround the fuel outlets 402B. The riser seals 424 may prevent fuel and/or anode exhaust from entering the air flow field 420 and contacting the cathode (e.g. SOFC air electrode) of an adjacent fuel cell 310. The riser seals 424 may also operate to prevent fuel from leaking out of the fuel cell stack 300 (see FIG. 3A).

Referring to FIG. 4B, the fuel side of the interconnect 400 may include fuel ribs 416 that at least partially define fuel channels 418 configured to provide fuel to the fuel electrode of an electrochemical cell (e.g., fuel cell) 310 disposed thereon. The fuel side of the interconnect 400 may be divided into a fuel flow field 430 including the fuel channels 418, and a perimeter seal surface 432 surrounding the fuel flow field 430 and the fuel inlets and outlets 402A, 402B. The fuel ribs 416 and fuel channels 418 may extend in a direction that is perpendicular or substantially perpendicular to the direction in which the air channels 408 and air ribs 406 extend.

A frame-shaped perimeter seal 434 may be disposed on the perimeter seal surface 432. The perimeter seal 434 may be configured to prevent air entering the fuel flow field 430 and contacting the fuel electrode on an adjacent electrochemical cell (e.g., fuel cell) 310. The perimeter seal 434 may also operate to prevent fuel from exiting the fuel risers 403, 405 and leaking out of the fuel cell stack 300 (see FIGS. 3A and 3B).

The seals 424, 434 may comprise a glass or ceramic seal material. The seal material may have a low electrical conductivity. In some embodiments, the seals 424, 434 may be formed by printing one or more layers of seal material on the interconnect 400, followed by sintering. As discussed in detail below, the air ribs 406 and/or the fuel ribs 416 may be formed of a metal oxide material and a remainder of the interconnect 400 may be formed of a Cr—Fe alloy or stainless steel.

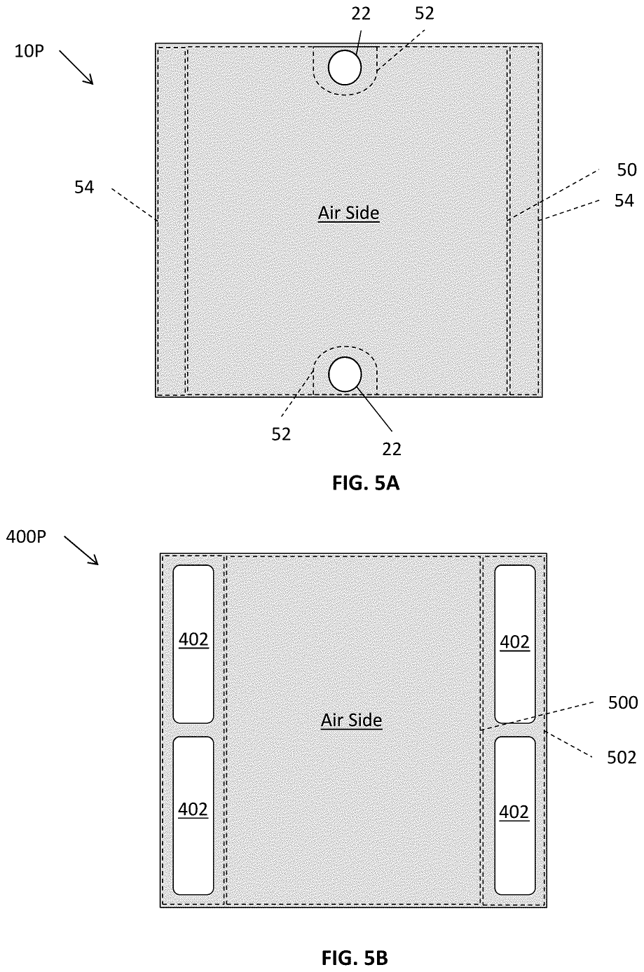

According to various embodiments of the present disclosure, a printing process is used to create metal oxide surface features on air sides of interconnect plates. FIGS. 5A and 5B are top views showing the air sides of interconnect plates 10P and 400P prior to forming air side surface features, according to various embodiments of the present disclosure.

Referring to FIG. 5A, the interconnect plate 10P may include fuel holes 22 and a flat air side having no surface features. Otherwise, the interconnect plate 10P has dimensions and fuel hole 22 layout similar to that of the interconnect 10 shown in FIGS. 2A and 2B. The air side may be divided into an air flow field region 50, strip seal regions 54 located on opposing sides of the air flow field region 50, and ring seal regions surrounding the fuel holes 22. The fuel side of the interconnect plate 10P may include surface features such as the fuel ribs 12, fuel channels 14, and fuel manifolds 28, as shown in FIG. 2B. In an alternative embodiment, the fuel side may include only some or none of the fuel side surface features. For example, the fuel side may include the fuel manifolds 28 and may omit the fuel ribs 12 and fuel channels 14, or the fuel side may be a flat surface having no surface features.

Referring to FIG. 5B, the interconnect plate 400P may include fuel holes 402 and a flat air side having no surface features. Otherwise, the interconnect plate 400P has dimensions and fuel hole 402 layout similar to that of the interconnect 400 shown in FIGS. 3B, 3C, 4A and 4B. The air side may be divided into an air flow field region 500 and riser seal regions 502 located on opposing sides of the air flow field region 500. The fuel side of the interconnect plate 400P may include the surface features such the fuel ribs 416 and fuel channels 418, as shown in FIG. 4B. In an alternative embodiment, the interconnect plate 400P may include some or none of the surface features shown in FIG. 4B.

Referring to FIGS. 5A and 5B, the interconnect plates 10P, 400P may be formed by pressing a Cr—Fe alloy powder using a powder metallurgy process. In an alternative embodiment, the interconnect plates 10P, 400P may be formed of stainless steel using a stamping, cutting, and/or molding process. The interconnect plates 10P, 400P may be sintered, oxidized, and optionally coated with a protective layer, as described above.

As discussed in more detail below, an ink may be applied to the air sides of the interconnect plates 10P, 400P to form surface features. For example, the ink may be applied to the air flow field regions 50, 500 using a screen or stencil printing process to form air ribs 16, 406 on the flat air sides of the interconnect plates 10P, 400P. In particular, multiple printed ink layers may formed on one another to build up surface features, such as the air ribs 16, 406.

The metal oxide ink may include metal oxide particles suspended in a carrier fluid. Suitable metal oxides may include manganese (Mn) and at least one of cobalt (Co), lanthanum (La), and/or strontium (Sr). In some embodiments, the ink may include particles of MCO, LSM, an MCO-LSM composite oxide, or the like. In some embodiments, the ink may include a single type of metal oxide particle or may include two or more different types of metal oxide particles. The metal oxide particles may represent, in volume percent, from about 55% to about 85%, such as from about 60% to about 80%, from about 65% to about 75%, of the volume of the ink.

In some embodiments, the carrier fluid may represent, in volume percent, from about 15% to about 45%, such as from about 20% to about 40%, from about 25% to about 35%, of the volume of the ink. Suitable carrier fluids include at least one of a liquid external phase (i.e., the liquid phase of a suspension) and/or at least one emulsifier. If the ink is a suspension, then the carrier fluid may comprise a liquid external phase (e.g., an organic liquid), and the metal oxide particles comprise an internal (e.g., a solid) phase which is suspended in the external phase of the suspension. Alternatively or in addition, the ink may include one or more organic emulsifiers instead of or in addition to the external phase. The carrier fluid provides the ink with a viscosity suitable for printing. For example, the organic liquid external phase may reduce the viscosity of a metal oxide powder and/or other solids suspended therein. The emulsifier may be configured to homogenize the ink and/or the organic external phase liquid(s), and thereby prevent and/or reduce solid internal phase precipitation out of the liquid external phase.

In various embodiments, the ink may optionally include glass particles suspended in the carrier fluid. The glass particles may be formed of a glass or glass-ceramic material as described above with respect to the seals 23, 24, 26, 424, 434 of FIGS. 2A, 2B, 4A, and 4B. The glass particles may represent, in volume percent, from about 2% to about 10%, such as from about 3% to about 7% of the volume of the ink. The glass particles may be configured to increase adhesion and/or flowability of the surface features formed using the ink. As such, the glass particles may improve control of the shape of the interconnect ribs, which improves the electrical contact between structural features formed by the printing and the interconnect plates 10P, 400P. The glass particles may be formed from a precursor material comprising, on an oxide basis from 25 mol % to 55 mol % SiO₂; from 20 mol % to 45 mol % CaO; from 5 mol % to 30 mol % MgO; and from 0 mol % (e.g., 0.5 mol %) to 15 mol % Al₂O₃.

In other embodiments, the ink may optionally include a dye. The dye may be configured to allow for an ink to be optically distinguishable from other inks to make sure that the ink printed layers are deposited in the right order and/or to increase contrast between the printed features and the underlying interconnect plate.

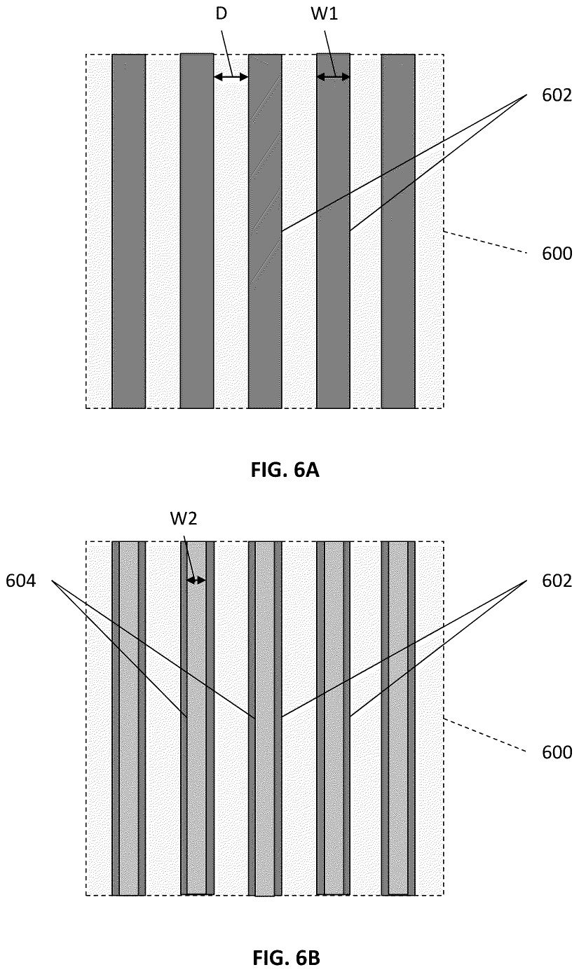

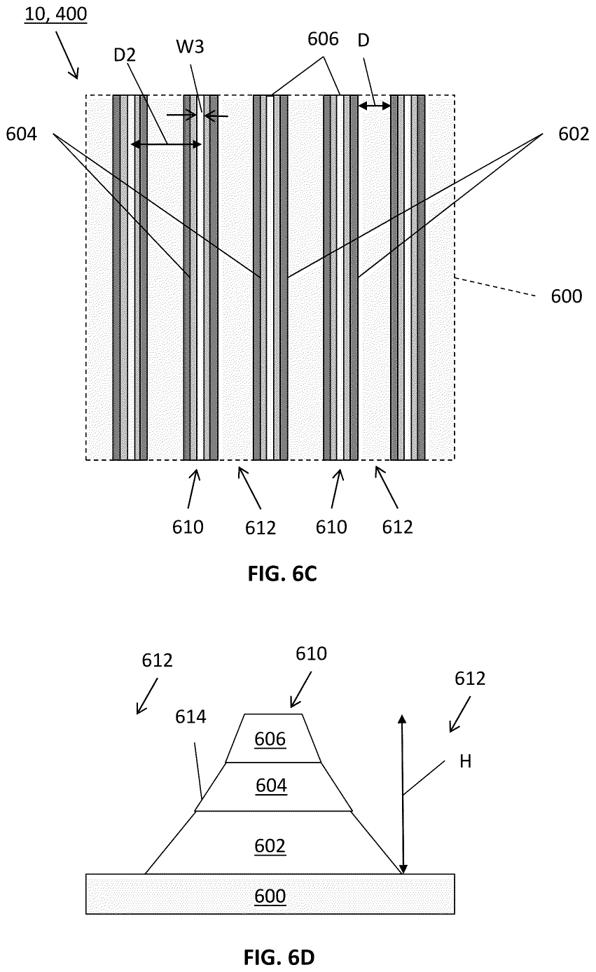

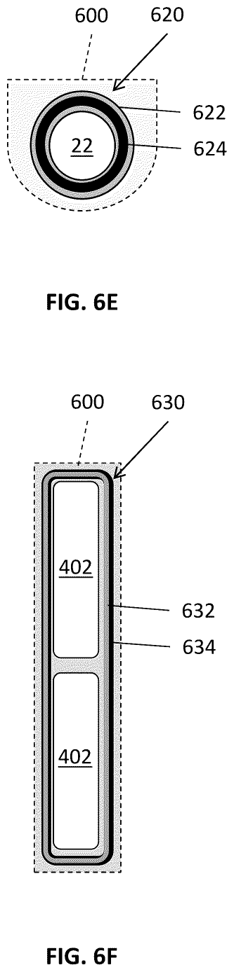

FIGS. 6A-6C illustrate a method of forming surface features on a portion of an interconnect plate 600, according to various embodiments of the present disclosure, FIG. 6D is a cross-sectional view of a rib 610 formed by the method, and FIGS. 6E and 6F are top views of barriers layers 620, 630 that may be formed by the method.

Referring to FIG. 6A, the interconnect plate 600 may be similar to either of the interconnect plates 10P and 400P shown in FIGS. 5A and 5B. A metal oxide ink may be selectively printed on the interconnect plate 600 and then dried to form one or more first layers 602. In particular, the first layers 602 may preferably be formed by screen printing or stencil printing, although any suitable printing or coating method may be used. The first layers 602 may be passively or actively dried after deposition. For example, in some embodiments the first layers 602 may be heated at a temperature ranging from about 100° C. to about 200° C., such as from about 125° C. to about 175° C., for a time period sufficient to drive off the organic carrier fluid. The first layers 602 may form first strips which correspond to the bottoms of the air ribs 16, 406.

As shown in FIG. 6B, the method may include printing a second layer 604 on each first layer 602. The second layers 604 may be formed of the same metal oxide ink as the first layers 602. Alternatively, the second layers 604 may be formed of a different metal oxide ink. The second layers 604 may be passively or actively dried after deposition. The second layers 604 are deposited on the first strips and may form second strips which correspond to the middle portions of the air ribs 16, 406. In one embodiment, the second strips are narrower than the first strips in the horizontal width direction perpendicular to the longer horizontal length direction.

As shown in FIG. 6C, the method may include depositing a third layer 606 on each second layer 604. The third layers 606 may be formed of the same metal oxide ink as the second layers 604. Alternatively, the third layers 606 may be formed of a different metal oxide ink. The third layers 606 may be passively or actively dried after deposition to form completed surface features. The third layers 606 are deposited on the second strips and may form third strips which correspond to the top portions of the air ribs 16, 406. In one embodiment, the third strips are narrower than the second strips in the horizontal width direction perpendicular to the longer horizontal length direction.

In one embodiment, the surface features formed by a stack of the first, second and third layers 602, 604, 606 may comprise ribs 610, as shown in FIGS. 6C and 6D. The ribs 610 may be air ribs (e.g., 16 or 406) formed on the air side of the interconnect plate 600. Alternatively or in addition, the ribs may comprise fuel ribs formed on the fuel side of the interconnect plate 600. Accordingly, the method may include printing air ribs, printing fuel ribs, or printing both air ribs and fuel ribs. In one embodiment, the ribs 610 may be air ribs 16 or 406 and the interconnect plate 600 may include fuel side surface features, such as fuel ribs 12 or 416, that are integrally formed during the formation of the interconnect plate 600 by powder metallurgy, stamping, molding, etc. For example, the interconnect plate 600 may include fuel ribs 416 (see FIG. 4B) formed during a powder metallurgy process used to from the interconnect plate 600.

The compositions of the layers 602, 604, 606 may be varied based on desired properties of the ribs 610. For example, the metal oxides and/or glass content of each of the layers 602, 604, 606 may be varied in order to form surface features that have a desired coefficient of thermal expansion (CTE), electrical conductivity, hardness, or the like.

As shown in FIGS. 6A-6D, the ribs 610 may at least partially define channels 612 therebetween. The channels 612 may be air channels or fuel channels, depending on whether the ribs 610 are air ribs or fuel ribs. While the ribs 610 and channels 612 are shown to be straight (e.g., extend in a single straight line direction), any suitable rib 610 and channel 612 configuration may be used. For example, curved ribs 610 may be used to form curved channels 612 that extend in more than one direction along their length.

As shown in FIG. 6D, the ribs 610 may have tapered sidewalls 614, such that the tops of the ribs 610 are narrower than the bottoms of the ribs 610. In this embodiment, the second layers 604 may have a second width W2 that is less than a first width W1 of the first layers 602, and the third layers 606 may have a third width W3 that is less than the second width W2. For example, the third width W3 may range from about 0.1 mm to about 0.5 mm, such as from about 0.25 mm to about 0.35 mm. Accordingly, the ribs 610 may have a tapered cross-section taken in a vertical direction perpendicular to the surface of the interconnect plate 600 and perpendicular to the length direction of the ribs 610. In some embodiments, the layers 602, 604, 606 may be formed using stencils or screens having progressively smaller openings. The ribs 610 may be separated by any suitable distance D between bottoms of adjacent ribs 610. For example, the distance D may range from about 0.75 mm to about 5 mm, such as from about 1 mm to about 2.5 mm. The centers of adjacent ribs 610 may be separated by any suitable distance D2. For example, the distance D2 between horizontal planes extending through a middle of each rib 610 in the same lateral direction as the long direction of the rib 610 may range from about 1.5 mm to about 2.5 mm, such as from about 1.9 mm to about 2.1 mm, in order to optimize the channel 612 width to sufficiently lower the pressure drop and to provide sufficient air flow on the air side for cooling, while maintaining sufficient lateral ion movement between the ribs 610 to provide high stack electrical performance. The ribs 610 may have a height H ranging from about 1 mm to about 7 mm, such as from about 2 mm to about 6 mm, or from about 3 mm to about 5 mm. The tops of the ribs 610 (e.g., the top surface of layer 606) are preferably flat to make a sufficient contact with an adjacent electrochemical cell.

The method may include forming more than three layers, or fewer than three layers to form the surface features. In particular, the number of layers used to form a surface feature may be based on the desired height and/or shape of the surface features and a thickness of the layers themselves. For example, forming thicker first and second layers 602, 604 may allow for the formation of surface features having the same height H as the ribs 610 formed using thinner first, second, and third 602, 604, 606 layers.

In summary, an interconnect 10, 400 according to one embodiment comprises a metal alloy interconnect plate 600 comprising an air side and an opposing fuel side, fuel ribs 12, 416 located on the fuel side, and metal oxide air ribs 610 located on the air side. The metal oxide air ribs 610 comprise at least 50 atomic percent oxygen throughout an entire height of the metal oxide ribs 610. In one embodiment, the metal oxide air ribs 610 comprise at least one of a spinel or perovskite oxide of manganese (Mn) and at least one of cobalt (Co), lanthanum (La), or strontium (Sr), such as manganese cobalt oxide (MCO), lanthanum stabilized manganite (LSM), or an MCO-LSM composite. Perovskite metal oxide, such as LSM, typically has two metal atoms for about three oxygen atoms (e.g., exactly three or slightly less than three in case of oxygen deficient LSM). Spinel metal oxide, such as MCO, typically has three metal atoms for about four oxygen atoms (e.g., exactly four or slightly less than four in case of oxygen deficient MCO). Thus the metal oxide air side ribs have a metal to oxygen ratio ranging from about 2:3 to about 3:4. Therefore, oxygen comprises at least 50 atomic percent of the metal oxide air ribs 610, such as about 57 atomic percent (for spinel metal oxide) to about 60 atomic percent oxygen (for perovskite metal oxide).

In one embodiment, the interconnect plate 600 comprises a steel interconnect plate or a Cr—Fe alloy interconnect plate comprising at least 90 weight percent chromium, 4 to 6 weight percent iron, and 4 weight percent or less oxygen. In one embodiment, the interconnect plate 600 comprises the Cr—Fe alloy interconnect plate comprising a chromium oxide containing material formed by oxidation of the Cr—Fe alloy interconnect plate filling pores in the Cr—Fe alloy interconnect plate. In this embodiment, the Cr—Fe alloy interconnect plate 600 is formed by pressing a powder comprising 94 to 96 weight percent chromium and 4 to 6 weight percent iron in a powder press to form a green Cr—Fe alloy interconnect plate having the flat air side and the Cr—Fe alloy fuel ribs located on the fuel side, sintering the green Cr—Fe alloy interconnect plate at an elevated temperature (e.g., a temperature of 700° C. to 1600° C., such as 1350° C. to 1550° C.), oxidizing the sintered Cr—Fe alloy interconnect plate; and removing a surface metal oxide (e.g., chromium oxide) from surfaces of the oxidized Cr—Fe alloy interconnect plate, such that a chromium oxide containing material (e.g., chromium oxide which may optionally contain some iron oxide) remains in pores in the Cr—Fe alloy interconnect plate 600.

In some embodiments, the method may include forming other surface features, such as, pillars, bumps, plateaus, combinations thereof, or the like, on the interconnect plate 600. For example, as shown in FIG. 6E, the method may include forming a barrier layer 620 around a fuel hole 22 of the interconnect plate 600. In particular, a first layer 622 may be formed by depositing a metal oxide ink on the air side of the interconnect plate 600 that surrounds the fuel hole 22. The first layer 622 may be dried, and a second layer 624 may be formed by depositing a metal oxide ink on the first layer 622. The barrier layer 620 may include two metal oxide layers as shown in FIG. 6E or may optionally include one or more additional metal oxide layers disposed on the second layer 622. The method may include forming the barrier layer 620 around all of the fuel holes 22 of the interconnect plate 600. The barrier layer 620 may comprise a corrosion barrier layer as disclosed in U.S. Pat. No. 10,763,533B1 , issued on Sep. 1, 2020 and incorporated herein by reference in its entirety. The barrier layer 620 may contain zirconium silicate and magnesium aluminosilicate crystals, and be formed from a precursor layer that comprises, on an oxide basis: from about 40 to about 60 wt. % ZrO₂; from about 30 to about 50 wt. % SiO₂; from about 5 to about 15 wt. % Al₂O₃; from about 2 to about 5 wt. % BaO; from about 2 to about 5 wt. % CaO; and from about 5 to about 15 wt. % of MgO.

As shown in FIG. 6F, the method may include forming a barrier layer 630 around fuel holes 402 of the interconnect plate 600. In particular, a first layer 632 may be formed by depositing a metal oxide ink on the air side of the interconnect plate 600 and surrounding the fuel hole 402. The first layer 632 may be dried, and a second layer 634 may be formed by depositing a metal oxide ink on the first layer 632. The barrier layer 630 may include two metal oxide layers as shown in FIG. 6F or may optionally include one or more additional metal oxide layers disposed on the second layer 632. The method may include forming barrier layers 630 around all of the fuel holes 402 of the interconnect plate 600. The barrier layer 630 may comprise a corrosion barrier layer having the same composition as the barrier layer 620 described above.

In some embodiments, the method may include forming multiple interconnects by forming surface features on interconnect plates 600 and assembling the interconnects with electrochemical cells and glass or glass-ceramic seals to form an electrochemical stack or column. The stack or column may be heated to reflow the seals.

In some embodiments, the method may include forming interconnects having different surface features, such as different ribs and corresponding channel configurations. As such, the interconnects of various embodiments may be tailored to provide different air and/or fuel flow rates. In some embodiments, interconnects may be fabricated with different surface features, based on whether the interconnect is intended for use with electrolyzer cells or fuel cells.

In various embodiments, specialized flow fields may be formed by controlling rib geometry using a printing process, such as the screen print process. Different metal oxide inks can be used to form surface feature layers to provide specific properties, such as a desired CTE. The flow field generation can be part of the stack manufacturing process to generate different flow field designs optimized for different SOFC/SOEC applications.

According to various embodiments, air side and/or fuel side interconnect surface features may be formed without using powder metallurgy. As such, compaction die wear may be significantly reduced, and less expensive compaction dies may be utilized. In addition, various embodiments allow for improved control and adjustment of surface feature morphology.

According to various embodiments, the surface features may be removed and replaced, which may increase the life cycle of an interconnect. In addition, a common interconnect plate may be used to produce interconnects having different air side surface features, thereby providing a volume production price benefit.

Fuel cell and electrolyzer cell systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An interconnect for an electrochemical cell stack, comprising:
a metal alloy interconnect plate comprising an air side and an opposing fuel side;
fuel ribs located on the fuel side; and
metal oxide air ribs located on the air side, wherein the metal oxide air ribs comprise at least 50 atomic percent oxygen throughout an entire height of the metal oxide ribs.

2. The interconnect of claim 1, wherein:
the interconnect plate comprises a steel interconnect plate or a Cr—Fe alloy interconnect plate comprising at least 90 weight percent chromium, 4 to 6 weight percent iron, and 4 weight percent or less oxygen; and
the metal oxide air ribs comprise at least one of a spinel or perovskite oxide of manganese (Mn) and at least one of cobalt (Co), lanthanum (La), or strontium (Sr).

3. The interconnect of claim 2, wherein:
the interconnect plate comprises the Cr—Fe alloy interconnect plate comprising a chromium oxide containing material formed by oxidation of the Cr—Fe alloy interconnect plate filling pores in the Cr—Fe alloy interconnect plate; and
the metal oxide ribs comprise manganese cobalt oxide (MCO), lanthanum stabilized manganite (LSM), or an MCO-LSM composite.

4. The interconnect of claim 2, wherein the air side ribs further comprise a glass or a glass-ceramic material.

5. The interconnect of claim 2, further comprising fuel holes that extend through the interconnect plate.

6. The interconnect of claim 1, wherein the air ribs each comprise:
a first metal oxide layer located on the air side of the interconnect plate; and
a second metal oxide layer located on the first metal oxide layer.

7. The interconnect of claim 6, wherein:
the first metal oxide layer comprises first strips;
the second metal oxide layer comprises second strips located on the first metal oxide layer; and
a width of the first strips is greater that a width of the second strips.

8. The interconnect of claim 7, wherein:
the air ribs each further comprise a third metal oxide layer comprising third strips located on the second strips; an the third strips having a width that is smaller than the width of the second strips; and
the air ribs have tapered sidewalls.

9. The interconnect of claim 2, wherein:
the interconnect plate comprises the Cr—Fe alloy interconnect plate;
the fuel ribs comprise the Cr—Fe alloy ribs that are formed integrally with the Cr—Fe alloy interconnect plate by powder metallurgy; and
the air ribs are printed on the air side of the Cr—Fe alloy interconnect plate.

10. An electrochemical cell stack, comprising:
interconnects of claim 1; and
electrochemical cells disposed between the interconnects.

11. A method of forming an interconnect for an electrochemical cell stack, the method comprising:
providing a metal alloy interconnect plate comprising a flat air side and an opposing fuel side containing fuel ribs; and
printing metal oxide air ribs on the air side using at least one ink comprising metal oxide particles.

12. The method of claim 11, wherein:
The interconnect plate comprises a steel interconnect plate or a Cr—Fe alloy interconnect plate comprising at least 90 weight percent chromium, 4 to 6 weight percent iron, and 4 weight percent or less oxygen; and
the at least one ink comprises a carrier fluid and the metal oxide particles comprising an oxide of manganese (Mn) and at least one of cobalt (Co), lanthanum (La), or strontium (Sr).

13. The method of claim 12, wherein the metal oxide particles comprise manganese cobalt oxide (MCO) particles, lanthanum strontium manganite (LSM) particles, MCO-LSM composite particles or a combination thereof.

14. The method of claim 12, wherein the step of providing the Cr—Fe alloy interconnect plate comprises:
pressing a powder comprising 94 to 96 weight percent chromium and 4 to 6 weight percent iron in a powder press to form a green Cr—Fe alloy interconnect plate having the flat air side and the Cr—Fe alloy fuel ribs located on the fuel side;
sintering the green Cr—Fe alloy interconnect plate;
oxidizing the Cr—Fe alloy interconnect plate; and
removing a surface metal oxide from surfaces of the Cr—Fe alloy interconnect plate, such that a chromium oxide containing material remains in pores in the Cr—Fe alloy interconnect plate.

15. The method of claim 12, wherein the at least one ink further comprises particles of a glass or glass-ceramic material.

16. The method of claim 11, wherein the printing comprises:
printing first metal oxide strips on the air side using the at least one ink; and
printing second metal oxide strips the first metal oxide strips using the at least one ink.

17. The method of claim 16, wherein a width of the first metal oxide strips is greater that a width of the second metal oxide strips.

18. The method of claim 17, wherein:
the printing further comprises printing third metal oxide strips on the second metal oxide strips using the at least one ink;
a width of the third metal oxide strips is greater that a width of the second metal oxide strips; and
the air ribs have tapered sidewalls.

19. The method of claim 11, wherein the printing comprises screen printing or stencil printing.

20. The method of claim 11, further comprising placing the interconnect into an electrochemical cell stack comprising a plurality of electrochemical cells.
